(19) United States
(12) Patent Application Publication
(10) Pub. No.: US 2006/0141077 A1
(43) Pub. Date: Jun. 29, 2006

(54) Pest controlling composition and the use thereof

(75) Inventor: Jan-Erik Pettersson, Uppsala (SE)

Correspondence Address: BACON & THOMAS, PLLC, 625 SLATERS LANE, FOURTH FLOOR, ALEXANDRIA, VA, 22314, US

(73) Assignee: ORGANOX AB, Ronninge (SE)

(21) Appl. No.: 10/537,352

(22) PCT Filed: Dec. 1, 2003
(86) PCT No.: PCT/SE03/01848

§ 371 Date: Oct. 31, 2005

(30) Foreign Application Priority Data
Dec. 6, 2002 (SE) 0203650-7

(51) Int. Cl. A01N 65/00

(52) U.S. Cl. 424/742; 424/747

(57) ABSTRACT

The invention relates to a composition and method for controlling a pest population, in particular an aphid population. The composition comprises menthol of 1,8-cineole and methyl salicylate.

### FIELD OF THE INVENTION

The present invention relates to a composition for controlling a pest population, in particular an aphid repellent composition, and to the use thereof for decreasing or eliminating pest infestation on agricultural, horticultural and ornamental plants.

### BACKGROUND OF INVENTION

There is a number of pests, including pathogenic organisms, which infest plants and cause economic loss of plant crops including cereal crops, horticultural crops, herbs, ornamental plant crops etc. Mention can be made of fungi, insects and nematodes.

Methods of controlling pests such as insects and soil pests often involve the use of pesticides such as organophosphates, pyrethrum, pyrethroids, mineral oil, and Bacillus thuringiensis crystal protein. Many of these compositions are toxic to large animals incl. man. Further, many compositions that function as pesticides accumulate in the environment to levels considered to be unsafe. A great problem is encountered when controlling pests on plants to be consumed by man, such as vegetables and herbs like dill, parsley etc. Here you do not want to have unwanted toxicity due to the use of toxic pesticides.

Economically important pathogenic organisms in this context are aphids and thrips.

Aphids pose a common plant protection problem and efforts to develop alternatives to conventional pesticides have met with only moderate success. As regards cereal aphids, it has not been possible to develop cereal varieties that combine satisfactory aphid resistance with good agronomic properties and yielding capacity (Åhman et al., 2000). Several crop management practices that increase the impact of natural enemies, such as beetle banks and unsprayed headlands, have been suggested (Chiverton, 1989; Chiverton & Sotherton, 1991) and have gained some acceptance by farmers in north west Europe. Expanding knowledge of the chemical ecology of aphids is stimulating speculation on the use of semiochemicals for aphid control (Chamberlain et al., 2001).

A key species in the cereal aphid complex in central Sweden is the bird cherry-oat aphid Rhopalosiphum padi (L.) (Wiktelius et al., 1990) which has Prunus padus L. (Rosaceae) as a winter host and wide range of grasses and cereals as summer hosts. The attack is usually well defined in time, and corresponds to an average of two and a half aphid generations born in the crop from the onset of immigration (late May/early June) until the maximum density is reached in the first half of July (Wiktelius et al., 1990). The crop is at that time rapidly maturing and drying out, preventing further aphid survival. Factors such as crowding, disturbed feeding and decreasing food quality gradually induce development of winged individuals (reviewed in Dixon, 1998).

However, and this is of great importance for the origin of the present invention, aphid behaviour is also effected by a density mechanism mediated by volatile compounds released at the feeding site when a certain density threshold is exceeded. These volatiles increase the sensitivity of aphids to disturbance, and promote mobility of non-settled individuals (Pettersson et al., 1995). The underlying mechanism is the so-called “odour communication”, an aspect of the plant's allelopathic behaviour.

Three key constituents of the R. padi density related substances (DRS) have been identified (Quiroz et al., 1997). The behavioural activity of these has been comfirmed under laboratory conditions, but the extent to which they have an effect on aphid establishment in a field crop under natural conditions is still open to question.

Methyl salicylate is associated with the winter host, P. padus, and plays an important role in the spring migration of R. padi (Pettersson et al., 1994; Glinwood & Pettersson 2000 a, b). It may act as a take off stimulus from P. padus, and it significantly reduced aphid settling when applied by spraying in cereal plots in a pilot experiment. Further studies have shown that methyl salicylate is produced by P. padus as a plant response to aphid feeding (Glinwood et al., unpublished; Glinwood & Pettersson, 2000 a). The effect on aphid settling in the field spraying experiment was not species specific, and it was hypothesised that methyl salicylate may also act as a plant defence inducing agent (Pettersson et al., 1994). This hypothesis has subsequently gained support from studies of pathogen-infested tobacco (Shulaev et al., 1997) and from the monitoring of PR proteins in cereal plants treated with methyl salicylate (Forslund et al., 2000).

U.S. Pat. No. 6,124,275, issued on 26th Sep. 2000, relates to a method for repelling ants from a plant comprising contacting the plant with a composition containing benzyl salicylate. Methyl salicylate is also mentioned as a compound of interest, it is true, but any insect repellent effect is neither disclosed nor indicated.

WO 99/56538, published on 11th Nov. 1999, relates to a method for controlling a pest population using a composition comprising a benzyl ester of an aromatic acid or aliphatic acid or salicylate, metyl salicylate being one of said salicylates. It is to be noted, however, that the compositions of WO 99/56538 are said to be efficacious pesticides, the efficacy being monitored by determining the mortality of or damage to the pest population, indicating that the compositions are ranked in the same category as ordinary insect-killing chemical pesticides.

WO 01/18201, published on 15th Mar. 2001, relates to a pesticide for cockroaches comprising methyl salicylate. Here use is made of the property of methyl salicylate to be strongly antagonistic or agonistic to octopamine receptor sites of insects.

None of the patent publications referred to above discloses nor indicates the pest controlling, and in particular, the aphid repellent activity of the compositions of the invention.

In view of the above, there is a need for plant pest controlling compositions comprising substances that as such repell plant pests, such as aphids, and, furthermore, activate or initiate plant defence against said pests by interplant communication released by plants infested by insects. A further criterion is that the compositions have no toxicity to agricultural, horticultural or ornamental plants and humans when used at a plant pest repellent level.

### SUMMARY OF THE INVENTION

The present invention is based on the surprising discovery that plant pest controlling compositions comprising menthol or 1,8-cineole or a combination thereof and optionally methyl salicylate are very effective pest repellent compositions. The compositions are especially effective against aphids.

Thus, the present invention is directed to a composition for controlling a plant pest population comprising 1,8-cineole or menthol or a combination thereof, optionally in combination with methyl salicylate.

The invention also relates to a method for controlling a plant pest population, particularly sucking insects such as aphids and thrips.

Further, the invention relates to an article of manufacture impregnated with a plant pest controlling composition of the invention and to be used for controlling a plant pest population.

### BRIEF DESCRIPTION OF THE DRAWINGS

FIG. 1 shows the direct repellent effect of menthol on Rhopalosiphum padi, Aphis fabae and Cavariella aegopodi in the olfactometer test.

FIG. 2 shows the R. padi response to menthol exposed plants.

FIG. 3 shows the proportion of aphids settling on barley exposed to 1,8-cineole for 3, 4 and 6 days.

FIG. 4 shows the response to odour of cineole-exposed plants in the olfactometer test.

FIG. 5 shows the R. padi response to a combination of menthol and methyl salicylate and to a combination of menthol, methyl salicylate and 1,8-cineole.

FIG. 6 shows the R. padi response to a mixture of the essential oils peppermint oil (menthol), wintergreen oil (methyl salicylate) and eucalyptus oil (1,8-cineole).

### DETAILED DESCRIPTION OF THE INVENTION

The compounds 1,8-cineole, menthol and methyl salicylate are available from commercial sources known in the art, such as Sigma-Aldrich. Essential oils containing said compounds, such as eucalyptus oil, peppermint oil and wintergreen oil, respectively, are also available from commercial sources, such as Crearome (www.crearome.se).

Methyl salicylate (Merck Index monograph number (9th Ed.) 5990) is 2-hydroxybenzoic acid methyl ester and is a component of wintergreen oil, betula oil, sweet birch oil and teaberry oil. The compound is an oily liquid with odour and taste of gaultheria, is slightly soluble in water and soluble in chloroform and ether. It is miscible with alcohols and glacial acetic acid.

The LD₅₀ orally in rabbits is 2.8 g/kg and the average lethal dose in human adults is 30 ml.

Methyl salicylate is used in perfumery, for flavoring candies etc.

Menthol (Merck Index monograph number (9th Ed.) 5663) is 5-methyl-2-(1-methylethyl)-cyclohexanol and is a component of peppermint oil and other mint oils. It is in the form of crystals or granulates and has a peppermint taste and odour.

Menthol is slightly soluble in water, very soluble in alcohol, chloroform, ether and petroleum ether and freely soluble in glacial acetic acid and liquid petrolatum. It is used in liqueurs, confectionary, perfumery, cigarettes, cough drops and nasal inhalers.

1,8-cineole (Merck Index monograph number (9th Ed.) 2280) is 1,3,3-trimethyl-2-oxabicyclo[2.2.2.]octane and is the chief constituent of eucalyptus oil. It is a colourless liquid and has a camphor-like odour and spicy cooling taste. It is practically insoluble in water but miscible with alcohol, chloroform, ether, glacial acetic acid and oils.

1,8-cineole is used therapeutically as an inhalational expectorant and is also an ingredient of throat lozenges and mouthwash.

According to a first aspect, the present invention relates to a composition for controlling a plant pest population comprising menthol or 1,8-cineole or a combination thereof, optionally also comprising methyl salicylate.

Plants suitable for treatment are those of agricultural and/or horticultural importance such as food crops, fruit trees and ornamental plants and flowers. Plants of particular importance in this context are vegetables and herbs, such as dill and parsley.

The terms “pest” and “pest population” refer to organisms, including pathogens, that negatively affect plants by colonizing, attacking or infecting them. These organisms include, by way of illustration, insects and particularly sucking or chewing insects such as thrips and aphids. Important aphids to be controlled are the bird cherry-oat aphid Rhopalosiphum padi on cereals, the black bean aphid Aphis fabae on legumes, vegetables and horticultural plants and the dill aphid Cavariella aegopodi on dill and other herbs, just to mention a few aphid species to be controlled.

The active ingredients of the compositions of the invention are biochemicals, i.e. they are substances of natural origin and have been proven to be substantially non-toxic to man and domestic animals and have minimal adverse effects on wildlife and the environment. As a matter of fact, as is shown above, the active ingredients of the claimed compositions are contained in different products intended to be consumed by man by swallowing, sucking or inhalation.

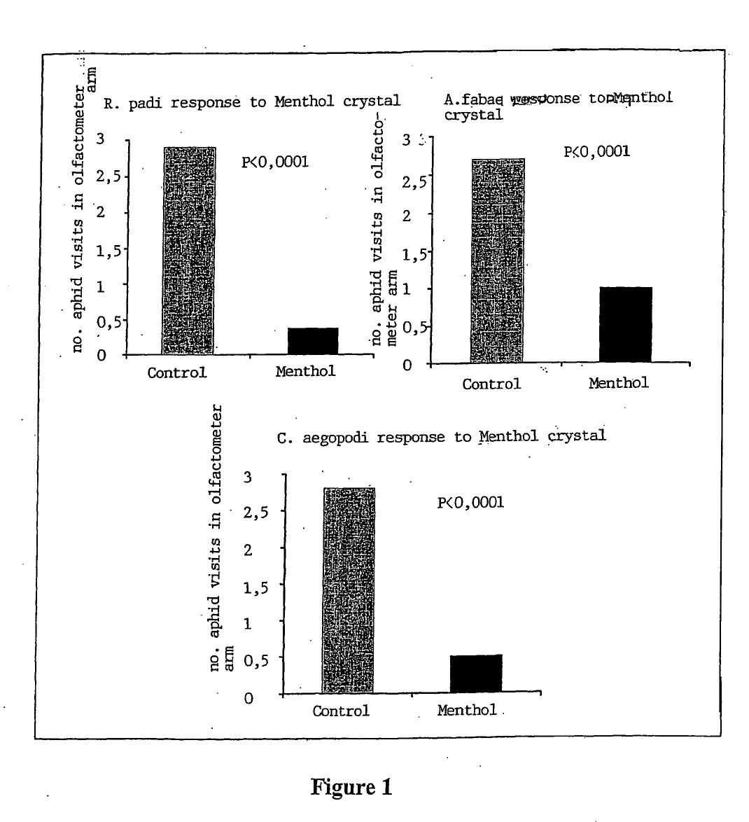

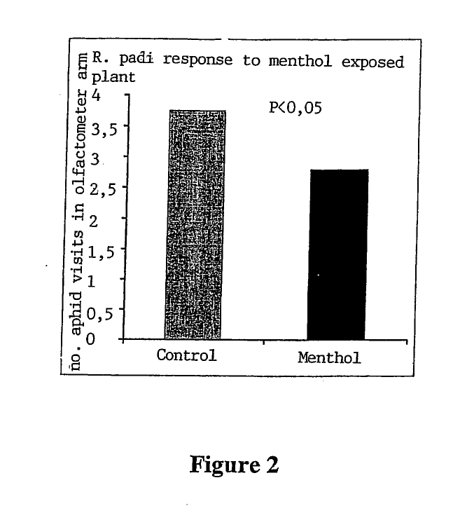

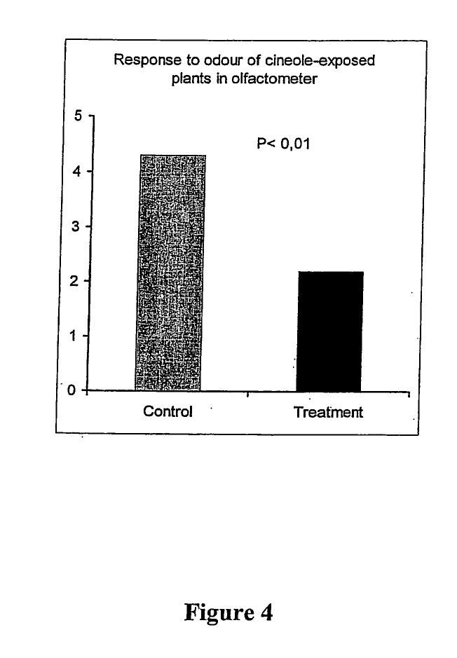

The active compounds have been found to change and effect the behaviour of aphids, particularly the settling behaviour, by two different mechanisms. Firstly, they have a direct aphid repellent effect as can be shown in the olfactometry test (cf. Example 2 below). This applies particularly to menthol (cf. FIG. 1) and methyl salicylate. Secondly, they also have an indirect aphid repellent effect by mediating the plant's self-repellent defence by odour communication. This applies in particular to menthol (cf. FIG. 2), methyl salicylate and 1,8-cineole (cf FIGS. 2 and 4).

The term “controlling” does not include killing of the pest population but encompasses the act of repelling the pest population by changing, effecting and disturbing the settling behaviour of the pest population and promoting the mobility of non-settled individuals. This is done by either a direct repelling effect or by inducing or mediating the plant's self-defence against attack by the pest population.

It is a great advantage to use a pest controlling composition, such as an aphid repellent composition, on herbs, vegetables etc. to be consumed by man which does not kill the pest population, e.g. aphids. Any dead aphids left on the plant would no doubt provide an appearance of the plant that would not be acceptable by the consumer.

An effective aphid repellent composition of the invention contains menthol and methyl salicylate in combination or menthol, methyl salicylate and 1,8-cineole in combination.

These effective combinations can also be realized by combining peppermint oil and wintergreen oil or by combining peppermint oil, wintergreen oil and eucalyptus oil as sources for the individual compounds.

As mentioned above, the active substances are all commercially available and can be obtained 99% pure. A good formulation of the active compounds must meet the demands of reproducibility, simplicity of execution, ease of release rate estimation in the field or greenhouse and acceptable release of active substances during the desired period of time, say 4-6 weeks. It has been decided that such a good formulation of the substances is a small distributable pellet and different potential carrier materials have therefore been tested. We have found that a mixture of two paraffins (Mobil 2360 and PEAC 6 in a 1:1 ratio) is a good carrier. The preparation of the pellets was carried out as follows. The two paraffin components were melted at 120° C. and the active compound added in an amount corresponding to 10% weight of the complete paraffin matrix. The mixture was immediately poured into a temperature-controlled aluminum container (8 cm inner diameter, 10 cm high, 1.5 cm wall thickness). The container had a lid and four brass nozzles, each with a 2 mm hole in the bottom through which the paraffin mixture could drip onto a slowly rotating aluminum disk (4 mm thick, 34 cm diameter). When the droplets fell onto the disk, a flat surface was created corresponding to about one third of the diameter of the spherical pellets. The speed of the disk was regulated so that the droplets could be scratched off as solid pellets. Keeping all temperatures constant, this gave a variation in pellet weight of <10%, and the loss of active compounds by evaporation from the mixture was <1%. Each pellet contained only a single substance, and pellets with different active substances were mixed to the desired proportions used in the treatment of field plots.

The composition of the invention may also be formulated in liquid form and may be a solution, suspension or emulsion depending on the needs of the user applying the pest controlling composition. Liquid compositions of the invention preferably contain, as a conditioning agent, one or more surfactants in amounts sufficient to render a given composition readily dispersible in water or an organic solvent. A water solvent is of course preferred because it is environmentally safe, is non-phytotoxic or non-dermal sensitive, and also costs little. Any agriculturally acceptable surfactant may be used. Particularly suitable surfactants are polyoxyethylated sorbitol fatty acid esters and polyethylene glycol octylphenol ethers. The amount of surfactant used is generally 0.5-10% by weight, typically 0.5-1%.

The subject composition can also include an antioxidant at a level sufficient to increase the product shelf life, inhibit decomposition of the active compound in the pest controlling composition or improve the stability of the controlling effects when the composition is applied to hosts infested with the pest population in question. Particularly suitable antioxidants include sodium benzoate, vitamin E and α-tocopherol. The amount of antioxidant used is in general about 0.01-10% by weight.

The subject liquid compositions may be prepared by simply mixing together the requisite amount(s) of active compound(s) and at least one agriculturally acceptable carrier, i.e. surfactant, and a solvent such as water. Other additives, such as antioxidants, may be included prior to mixing.

The actual value of the percentage amount for the active substance or substances in the subject composition is preferably determined by routine screening procedures employed to evaluate pest controlling activity and efficacy, such as are well known by those skilled in the art and are described in the Examples. The percentage amount of active compound used has preferably minimal or no adverse effect on agricultural and ornamental plants (such as phytotoxicity), wildlife and humans that may come in contact with such compounds.

According to a second aspect, the present invention relates to a method for controlling a plant pest population which method comprises contacting the pest population with an amount of a pest controlling composition of the invention effective to control said pest population.

The method is preferably used for controlling an insect population, and especially sucking and chewing insects such as aphids and thrips.

Aphid species particularly suitable to control in the method of the invention are Rhopalosiphum padi, Aphis fabae and Cavariella aegopodi.

A preferred method comprises spraying the pest controlling composition onto the soil where the plants are growing or onto the foliage of the plants. Another preferred method includes applying the composition in the vicinity of the plants by means of impregnated pellets, sticks, poles and woven fabrics.

Whatever method is used, it is of importance that the amount of the composition applied is effective to control the pest population in question, i.e. effective to change and disturbe the settling behaviour of the pest population to the desired degree. Also here applies that the actual value of the effective amount to be applied for (a) given active compound(s) is preferably determined by routine screening procedures employed to evaulate the pest controlling activity and efficacy, such as are well known by those skilled in the art and are described in the Examples.

According to a third aspect, the present invention relates to an article of manufacture being impregnated with a pest controlling composition of the invention. Such articles are, by way of illustration, pellets, sticks, poles and woven fabrics. The sticks and poles may be located in the vicinity of the plants such as between the plants. The pellets may be applied to the soil in which the plants are growing.

The efficacy of the compositions and methods of the invention is further illustrated by the Experimental Section below.

### EXPERIMENTAL SECTION

### Experimental Methods

Aphids

Aphids tested were the bird cherry-oat aphid Rhopalosiphum padi (cereals), black bean aphid Aphis fabae (legumes, vegetables, horticultural plants) and dill aphid Cavariella aegopodi (dill and other herbs).

Exposure of Plants to Allelopathic Chemicals

Exposure of barley plants to volatile chemicals was done in perspex ‘two-chamber cages’ (Pettersson et al. 1999) attached to a vacuum tank. Air was taken into the first chamber through a hole in the cage wall, passed into the second chamber and was then drawn out from the top of this cage to a vacuum tank before being vented outside the room. Plants were placed in the second chamber, and chemicals were released from microcapillary tubing which hung in the first chamber. Plants were exposed for 5 days, after which time they were removed and used in tests of aphid behaviour. Control plants grew in identical cages with empty microcapillary tubes.

Olfactometry

Responses of R. padi migrants to chemical odours were tested in a 4-way olfactometer (Pettersson, 1970), consisting of an enclosed Perspex arena (12 cm diameter) with a central chamber and four side arms. Air was drawn from the centre of the olfactometer using a water pump, establishing distinct airflow in the side arms. An odour field was established by introducing a chemical (released from a 10 ml capillary tube, or a whole menthol crystal, weight: 0.14 g) into one of the side arms. A single adult apterous aphid was introduced into the olfactometer, and its position was recorded every 3 minutes for 30 minutes. The number of visits to the treatment arm was compared with the mean number of visits to the control arms using a paired t-test. Experiments were repeated 16-20 times (no. individual aphids tested), with the olfactometer turned through 90° between replicates to avoid positional bias. Olfactory responses to plants exposed to chemicals were done in a similar way, except that the odour sources consisted of whole plants enclosed in two-chamber cages attached directly to the olfactometer. In each olfactometer, one treated plant was compared with one untreated plant.

Test of Aphid Settling

A 50 ml polystyrene tube was placed over the youngest fully developed leaf. The upper end of the tube was covered with a net and the lower end with a foam plastic plug with a slit for the leaf. To minimise mechanical damage to the test plant, a stick was used to support the tube. Ten mixed-instar apterous aphids were placed in the tube and after 2 hours the number of aphids settled (not walking) on the leaf was recorded. Occasionally aphids were able to escape from the tubes, but the results were expressed as a proportion of the number of aphids originally introduced, in case the propensity of an aphid to escape from the tube was influenced by the experimental treatment of the plant. The number of replicates (tubes) varied between experiments, but there were always equal numbers of control and treatment plants. Typically four plants per pot (and therefore per cage since each cage held a single pot) were randomly selected for the test, and each pot was considered to be a block for the statistical analysis.

Results

Response to Menthol

Rhopalosiphum padi, Aphis fabae and Cavariella aegopodi were all strongly repelled by menthol in the olfactometer (FIG. 1). Rhopalosiphum padi was repelled by the odour of plants that had been exposed to menthol (FIG. 2).

Response to Plants Exposed to 1,8-cineole

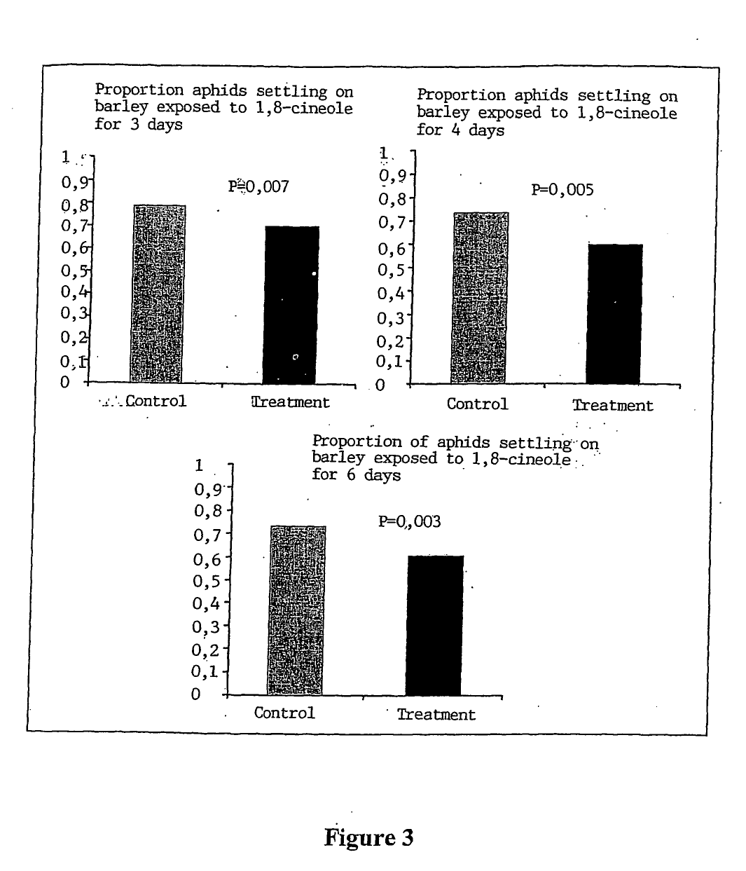

Aphids did not respond to 1,8-cineole alone in the olfactometer. However, aphids settled significantly less on plants that had been exposed to the substance (FIG. 3). Therefore the substance causes a change in the plants that makes them less acceptable to the aphid. The odour of plants exposed to 1,8-cineole was also less attractive to aphids in the olfactometer (FIG. 4).

Response to Combinations of Chemicals

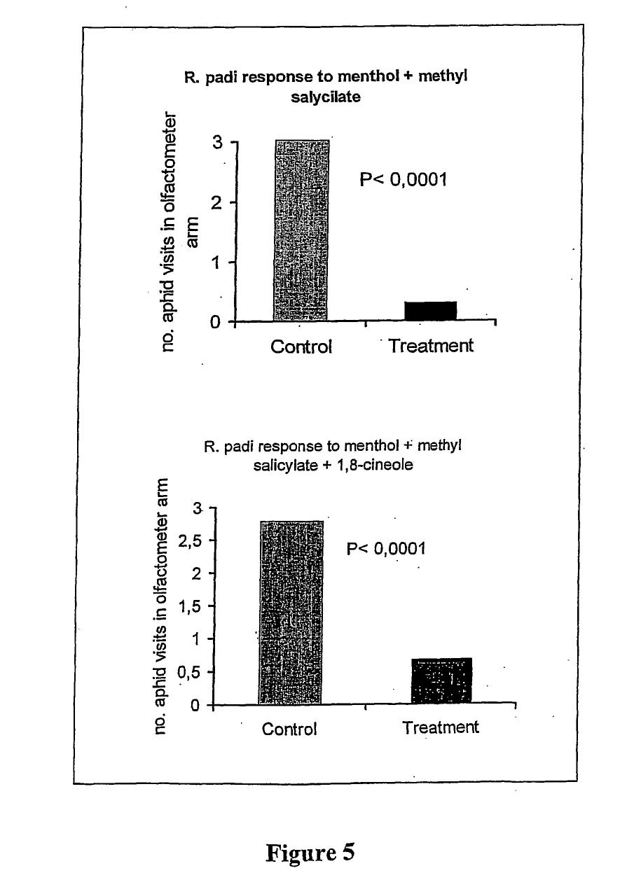

Combinations of menthol+methyl salicylate and menthol+methyl salicylate+1,8-cineole had activities similar to the individual compounds (FIG. 5).

Response of R. padi to Essential Oils

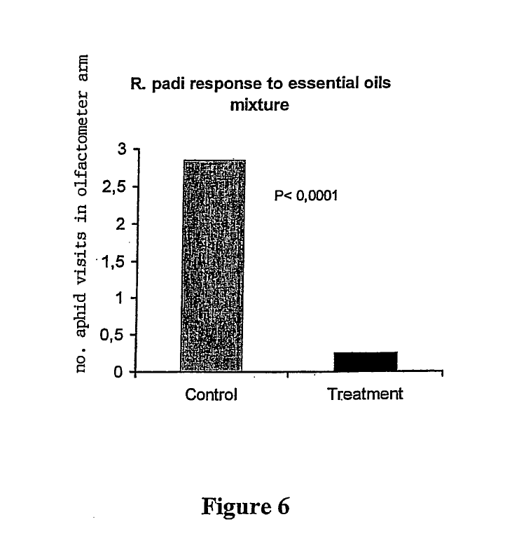

Essential oils were purchased from Crearome (www.crearome.se). A mixture of peppermint oil (menthol), wintergreen oil (methyl salicylate) and eucalyptus oil (E. smithii-1,8-cineole) (10 μl each) was very repellent to R. padi in the olfactometer (FIG. 6).

Conclusions

Menthol and methyl salicylate are strong repellents for several aphid species. Methyl salicylate promotes an induced plant defence against aphids, and there is evidence that menthol does so too. 1,8-cineole is not directly active against aphids but promotes an induced plant defence. The substances are very effective in combination with each other. The combination of essential oils containing the individual substances is equally effective.

### REFERENCES

Åhman, I., Tuvesson, S., Johansson, M. (2000) Does indole alkaloid confer resistance in barley to aphid Rhopalosiphum padi? Journal of Chemical Ecology, 26, 233-255.
Chamberlain, K., Guerrieri, E., Pennacchio, F., Pettersson, J., Pickett, J. A., Poppy, G. M., Powell, W., Wadhams, L. J. & Woodcock, C. M. (2001) Can aphid-induced plant signals be transmitted aerially and through the rhizosphere? Biochemical Systematics and Ecology, 29, 1063-1074.
Chiverton, P. A. (1989) The creation of with-in field overwintering sites for natural enemies of cereal aphids. Proceedings of the BCPC Weeds 1989, Brighton, UK, 3, 1093-1096.
Chiverton, P. A. & Sotherton, N. W. (1991) The effects on beneficial arthropods of the exclusion of herbicides from cereal crop edges. Journal of Applied Ecology, 28, 1027-1039.
Dixon, A. F. G. (1998) Aphid Ecology, 2^{nd} Edition. Chapman & Hall, London, London.
Forslund, K., Pettersson, J., Bryngelsson, T. & Jonsson, L. (2000) Aphid infestations induces PR-proteins differently in barley susceptible or resistant to the bird cherry-oat aphid Rhopalosiphum padi (L.). Physiol Plantarum, 110, 496-502.
Glinwood, R. & Pettersson, J. (2000a) Host plant choice in Rhopalosiphum padi spring migrants and the role of olfaction in winter host leaving. Bulletin of Entomological Research, 90, 57-61.
Glinwood, R. & Pettersson, J. (2000b) Change in response of Rhopalosiphum padi spring migrants to the repellent winter host component methyl salicylate. Entomologia Experimentalis et Applicata, 94, 325-330.
Pettersson, J., 1970. Studies on Rhopalosiphum padi (L.). Laboratory studies on olfactometric responses to winter host Prunus padus L. Lantbrukshögskolans Annaler 36: 381-399.
Pettersson, J., Pickett, J. A., Pye, B. J., Quiroz, A., Smart, L. E., Wadhams, L. J. & Woodcock, C. M. (1994) Winter host component reduces colonization of summer hosts by the bird cherry-oat aphid, Rhopalosiphum padi (L.). and other aphids in cereal fields. Journal of Chemical Ecology, 20, 2565-74.
Pettersson, J., Quiroz, A., Stephansson, D. & Niemeyer, H. M. (1995) Odour communication of Rhopalosiphum padi (L.) (Hom.: Aph.) on grasses. Entomologia Experimentalis et Applicata, 76, 325-328
Pettersson, J., V. Ninkovic, and F. E. Ahmed. 1999. Volatiles from different barley cultivars affect aphid acceptance of neighbouring plants. Acta Agriculturae Scandinavica. Section B, Soil and Plant Science 49:152-157.
Quiroz, A., Pettersson, J., Pickett, J. A., Wadhams, L. & Niemeyer, H. M. (1997) Key compounds in a spacing pheromone in the bird cherry-oat aphid, Rhopalosiphum padi (L.) (Hemiptera, Aphididae). Journal of Chemical Ecology, 23, 2599-2607.
Shulaev, V., Silverman, P. & Raskin, I. (1997) Airborne signalling by methyl salicylate in plant pathogen resistance. Nature, 385, 718-721.
Wiktelius, S., Weibull, J. & Pettersson, J. (1990) Aphid host plant ecology: The bird cherry oat aphid as a model. In, Aphid-Plant Genotype Interactions (ed by R. K. Campbell & R. D. Eikenbary), Elsevier Science Publishers B.V., Amsterdam.

1. A composition for controlling a plant pest population comprising 1,8-cineole, menthol and methyl salicylate.

2. The composition of claim 1 comprising eucalyptus oil as a source for 1,8-cineole.

3. The composition of claim 1 comprising peppermint oil as a source for menthol.

4. The composition of claim 1 comprising wintergreen oil as a source for methyl salicylate.

5. The composition of claim 2 comprising a mixture of peppermint oil, wintergreen oil and eucalyptus oil.

6. The composition of claim 1 comprising, in addition, an agriculturally or horticulturally acceptable carrier.

7. A method for controlling a plant pest population, which method comprises contacting the pest population with an amount of a composition of claim 1 effective to control said pest population.

8. The method of claim 7, wherein said pest population is an insect population.

9. The method of claim 8, wherein said insect population is a sucking insect population selected from the group consisting of aphids and thrips.

10. The method of claim 9, wherein said pest population is an aphid population selected from Rhopalosiphum padi, Aphis fabae and Cavariella aegopodi.

11. The method of claim 7, wherein said composition is applied to the plant by spraying.

12. The method of claim 7, wherein said composition is applied onto the soil or in the vicinity of said plant.

13. The method of claim 10, wherein the plant to be treated is dill and the aphid population is Cavariella aegopodi.

14. An article of manufacture being impregnated with a pest controlling composition to be used in the method of controlling a plant pest population of claim 7.

15. The article of claim 14 being selected from the group consisting of pellets, sticks, poles and woven fabric.
